(19) United States
(12) Patent Application Publication
(10) Pub. No.: US 2026/0051111 A1
(43) Pub. Date: Feb. 19, 2026

(54) INFORMATION PROCESSING SYSTEM, INFORMATION PROCESSING METHOD, AND STORAGE MEDIUM

(71) Applicant: CANON KABUSHIKI KAISHA, Tokyo (JP)

(72) Inventors: MAMORU TANAE, Saitama (JP); AZUSA MATSUMOTO, Kanagawa (JP); HIDEKAZU KAMEI, Kanagawa (JP); YUSUKE OKABE, Tokyo (JP)

(21) Appl. No.: 19/298,898

(22) Filed: Aug. 13, 2025

(30) Foreign Application Priority Data
Aug. 19, 2024 (JP) 2024-137658

(51) Int. Cl. G06T 15/20; G06T 17/00; G06T 19/00

(52) U.S. Cl. CPC G06T 15/20; G06T 17/00; G06T 19/006

(57) ABSTRACT

An information processing system includes one or more memories storing instructions, and one or more processors executing the instructions to acquire a plurality of three-dimensional models generated based on a plurality of captured images obtained by concurrently capturing objects each corresponding to a respective image capturing project of a plurality of image capturing projects, and acquire position information of a capture area corresponding to each of the plurality of image capturing projects, associate, based on the plurality of three-dimensional models and the position information, each of the plurality of image capturing projects with a three-dimensional model existing within the capture area corresponding to the image capturing project, and output information indicating a combination of the associated image capturing project and the three-dimensional model.

### BACKGROUND

### Field of the Technology

The present disclosure relates to a three-dimensional (3D) model of an object generated based on a plurality of captured images.

### Description of the Related Art

Some known techniques utilize a three-dimensional (3D) model of an object, generated from a plurality of images captured by an image-capturing system including a plurality of image capturing apparatuses, to produce virtual viewpoint images which are images from a virtual viewpoint. This technology enables the provision of virtual viewpoint images from positions where actual cameras cannot be placed in, for example, sports such as soccer and basketball.

Japanese Patent Laid-open No. 2016-203598 describes a system of capturing an image for each customer in a photo studio, creating a folder for each customer to manage the images. If the system is applied to a system for generating a virtual viewpoint image, the system of capturing an image of an object for each image capturing project, and managing a 3D model of the object for each image capturing time may be conceivable.

However, in a studio in which virtual viewpoint images are generated, image capturing may be performed concurrently for a plurality of image capturing projects for efficiency. In this case, the generated 3D models need to be managed for each image capturing project, but such a system has not been conceived yet.

### SUMMARY

The present disclosure is directed to a system that easily manages generated three-dimensional (3D) models for each image capturing project.

According to an aspect of the present disclosure, an information processing system includes one or more memories storing instructions, and one or more processors executing the instructions to acquire a plurality of three-dimensional models generated based on a plurality of captured images obtained by concurrently capturing objects each corresponding to a respective image capturing project of a plurality of image capturing projects, and acquire position information of a capture area corresponding to each of the plurality of image capturing projects, associate, based on the plurality of three-dimensional models and the position information, each of the plurality of image capturing projects with a three-dimensional model existing within the capture area corresponding to the image capturing project, and output information indicating a combination of the associated image capturing project and the three-dimensional model.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of an entire system according to a first embodiment.

FIG. 2 is a block diagram illustrating an example of a hardware configuration of an information processing apparatus.

FIG. 3 is a table illustrating an example of project identification information according to the first embodiment.

FIG. 4 is a diagram illustrating processing of identifying an image capturing project corresponding to a three-dimensional (3D) model of an object according to the first embodiment.

FIG. 5 is a flowchart illustrating processing performed by a project identification unit according to the first embodiment.

FIG. 6 is a table illustrating information indicating combinations of 3D models and corresponding image capturing projects generated by the project identification unit according to the first embodiment.

FIG. 7 is a diagram illustrating a confirmation screen for confirming the information indicating the combinations of 3D models and corresponding image capturing projects displayed on an output unit according to the first embodiment.

FIG. 8 is a diagram illustrating an image capturing project file including data for each image capturing project according to the first embodiment.

FIG. 9 is a sequence diagram illustrating a process of displaying an augmented reality (AR) image of a 3D model of an object corresponding to an image capturing project according to the first embodiment.

FIGS. 10A and 10B are diagrams illustrating an example of an AR image displayed on a user terminal according to the first embodiment.

FIG. 11 is a block diagram illustrating an entire system according to a second embodiment.

FIG. 12 is a table illustrating an example of project identification information according to the second embodiment.

FIG. 13 is a diagram illustrating an image capturing system according to the second embodiment.

FIG. 14 is a flowchart illustrating processing which is performed by a project identification unit according to the second embodiment.

FIG. 15 is a diagram illustrating an image capturing time file including data for each image capturing time according to a third embodiment.

FIG. 16 is a sequence diagram illustrating a process of displaying an AR image of a 3D model of an object corresponding to an image capturing project according to the third embodiment.

### DESCRIPTION OF THE EMBODIMENTS

### Embodiments

According to embodiments of the present disclosure, an information processing system includes an acquisition unit configured to acquire a plurality of three-dimensional (3D) models generated based on a plurality of captured images acquired by capturing objects corresponding to the corresponding one of a plurality of image capturing projects. The information processing system includes an association unit configured to associate one of the plurality of image capturing projects and one of the plurality of 3D models. The information processing system includes an output unit configured to output information indicating the combination of the one of image capturing projects and the one of 3D models associated by the association unit.

This configuration can facilitate easy management of the 3D models of objects for the corresponding image capturing projects even in the case where image capturing is performed concurrently for the plurality of image capturing projects and the 3D models of the plurality of objects are generated. There is a plurality of management methods, and, for example, a file for each of the image capturing projects may be generated using the information indicating the combination of the image capturing project and the corresponding 3D model(s). This file includes the 3D model(s) of the image corresponding to the image capturing project, and does not include the 3D models of the objects not corresponding to the image capturing project. The data including the 3D models of the plurality of objects corresponding to the plurality of image capturing projects, and the combinations of the image capturing projects and the 3D models may be associated and managed. In such a case, when a virtual viewpoint image is generated using the 3D model, the 3D models of the objects corresponding to the image capturing projects different from a desired image capturing project from among the plurality of image capturing projects are made transparent. In this way, the virtual viewpoint image including only the 3D model(s) of the object corresponding to the desired image capturing project can be generated.

The association unit associates one of the plurality of image capturing projects and one of the plurality of 3D models based on position information about the one of the plurality of 3D models. There are a plurality of possible association processing methods, and, for example, assume that the plurality of image capturing projects is each associated with a corresponding area of areas different from one another. In this case, an image capturing project associated with an area including one of the plurality of 3D models from among the plurality of image capturing projects, and one of the plurality of 3D models are associated. Another association processing method of using a tracking device may be considered. For example, the plurality of image capturing projects is each associated with a corresponding tracking device of a plurality of tracking devices different from one another, and an image capturing project associated with one of the tracking devices located closest to the position of one of the plurality of 3D models from among the plurality of image capturing projects is associated with the one of the plurality of 3D models.

The information processing system includes a generation unit configured to generate a plurality of files each including a 3D model of an object corresponding to an image capturing project, based on the information indicating the combinations of the image capturing projects and the 3D models. The plurality of generated files is recorded in a recording unit. The recording unit is assumed to be a database accessible by a user via a management server. The information processing system includes an identification unit configured to identify the file corresponding to the image capturing project specified by a first user operation from among the plurality of files. The first user operation is an operation of capturing an image of a quick response (QR®) code or a marker by a user using a camera mounted on a smartphone or a tablet terminal. Through this operation, the information processing system can acquire information for identifying the image capturing project indicated by the QR® code or the marker, and can access the database via the management server.

With this configuration, a user can acquire the 3D model of the object corresponding to the desired image capturing project.

The information processing system includes a generation unit configured to generate a virtual viewpoint image using the 3D model included in the identified file.

This configuration enables a user to view the virtual viewpoint image generated using the 3D model of the object corresponding to the desired image capturing project.

The information processing system includes a display control unit configured to perform control to display a composited image that can be generated based on a captured image acquired based on a second user operation, and the virtual viewpoint image.

The second user operation is an operation for capturing an image of a scenery or an object using a camera mounted on a smartphone or a tablet terminal. The first user operation and the second user operation may be the same.

This configuration enables the user to view an augmented reality (AR) image using the virtual viewpoint image.

The information processing system includes a correction unit configured to correct the information indicating the combinations of the image capturing projects and the corresponding 3D models based on a third user operation. The third user operation is an operation performed by an administrator who manages the image capturing for determining whether the combinations of the image capturing projects and the corresponding 3D models are appropriate, and correcting the combinations when inappropriate. For this reason, the first user operation and the third user operation are performed by different users.

### First Embodiment

Hereinbelow, embodiments of the present disclosure will be described in detail with reference to the attached drawings. The embodiments described below are not intended to limit the present disclosure, and not all the combinations of the features described in the embodiments are necessarily essential for the solutions in the present disclosure. Further, in the attached drawings, the same or similar components are assigned the same reference numbers, and redundant descriptions thereof are omitted.

In a first embodiment, an information processing system concurrently performs image capturing for a plurality of image capturing projects in a single studio, and generates a plurality of 3D models including a plurality of objects corresponding to the plurality of image capturing projects. Subsequently, each 3D model is identified in terms of which image capturing project it corresponds to, and information indicating the combination of each 3D model and the corresponding image capturing project is generated. A manager responsible for managing image capturing projects refers to this information to associate each 3D model with the corresponding image capturing project. As a result, even in a case where image capturing is performed concurrently for a plurality of image capturing projects, the 3D models can be easily managed on a per-image-capturing-project basis.

As an example method for utilizing the result of association of 3D models with image capturing projects, it is assumed that a file including the 3D model of the corresponding object is generated for each of the image capturing projects, and uploaded to the cloud. The user who has requested the image capturing project can access the cloud via a management server, obtain a virtual viewpoint image generated by the management server using the 3D model corresponding to the requested image capturing project, and view the virtual viewpoint image on their terminal device.

The information processing system is configured to generate a virtual viewpoint image representing a scene viewed from a designated virtual viewpoint, based on a plurality of images captured by a plurality of image capturing apparatuses, and the designated viewpoint. The virtual viewpoint image in the present embodiment is also referred to as a free-viewpoint image, but it is not limited to the image corresponding to the viewpoint designated freely (arbitrarily) by a user, and, for example, an image corresponding to a viewpoint selected by a user from among a plurality of candidates is also included in the virtual viewpoint image. In the present embodiment, a description is provided focusing on a case where the virtual viewpoint is designated by a user operation, but the virtual viewpoint may be automatically designated based on a result of an image analysis or the like. In the present embodiment, a description is provided focusing on a case where the virtual viewpoint image is a moving image, but the virtual viewpoint image may be a still image.

The viewpoint information to be used for generating the virtual viewpoint image is information indicating a position and an orientation (line-of-sight direction) of the virtual viewpoint. More specifically, the viewpoint information is a parameter set including parameters indicating the 3D position of the virtual viewpoint, and parameters indicating the orientation of the virtual viewpoint in the pan, tilt, and roll directions. The details of the viewpoint information are not limited thereto. For example, the parameter set serving as the viewpoint information may include parameters indicating the size of a field of view (angle of view) of the virtual viewpoint. The viewpoint information may include a plurality of parameter sets. For example, the viewpoint information may include a plurality of parameter sets corresponding to each frame that constitutes a moving image of virtual viewpoint images, thus representing the position and orientation of the virtual viewpoint at each of a plurality of consecutive time points.

The information processing system includes a plurality of image capturing apparatuses for capturing an image capturing area from a plurality of directions. The image capturing area is, for example, a stadium used for sports competitions, such as soccer games and karate competitions, or a stage where concerts or theatrical performances take place. The plurality of image capturing apparatuses is arranged at different positions surrounding the image capturing area to perform synchronized image capturing. The plurality of image capturing apparatuses does not necessarily need to be arranged around the entire the image capturing area, and may be arranged on part around the image capturing area, depending on limitations on the installation locations. Further, the number of the image capturing apparatuses is not limited to the example illustrated in the drawings, and, for example, in a case where the image capturing area is a soccer stadium, approximately thirty image capturing apparatuses may be arranged around the athletic field. Further, image capturing apparatuses different in function, such as telephoto cameras and wide-angle cameras, may be arranged.

In addition, the plurality of image capturing apparatuses in the present embodiment is assumed to be cameras each having an independent housing and capable of capturing an image from a single viewpoint. However, the configuration for the image capturing apparatuses is not limited thereto, and two or more image capturing apparatuses may be included in the same housing. For example, a single camera provided with a plurality of lens groups and a plurality of image sensors and capable of capturing images from a plurality of viewpoints may be arranged as the plurality of image capturing apparatuses.

### System Configuration

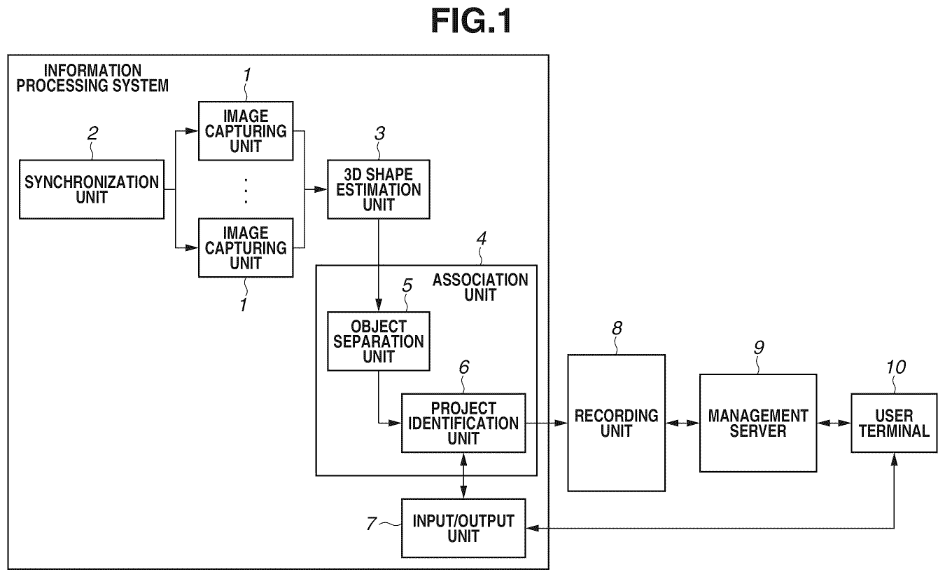

FIG. 1 is a block diagram illustrating an example of an entire system according to a first embodiment.

The entire system includes the information processing system, a recoding unit 8, a management server 9, and a user terminal 10. The information processing system includes a plurality of image capturing units 1, a synchronization unit 2, a 3D shape estimation unit 3, an association unit 4, and an input/output unit 7. The association unit 4 includes an object separation unit 5 and a project identification unit 6. Each component of the information processing system may include a plurality of apparatuses, or a plurality of components may be included in one apparatus. Hereinbelow, descriptions are provided assuming that the association unit 4 is a single information processing apparatus, and the other components are each configured of an individual apparatus.

The plurality of image capturing units 1 performs image capturing in synchronization with each other based on a synchronization signal from the synchronization unit 2. Each of the image capturing units 1 outputs a captured image to the 3D shape estimation unit 3. The plurality of image capturing units 1 is arranged so as to surround an image capturing area including an object so that the image capturing units 1 can capture an object from a plurality of directions.

The synchronization unit 2 outputs the synchronization signal to the plurality of image capturing units 1.

The 3D shape estimation unit 3 generates, for example, a silhouette image of the object using the plurality of input captured images, to generate a 3D shape of the object using a volume intersection method or the like.

In the present embodiment, the 3D shape of the object is referred to as a 3D model of the object. The 3D model of the object may include color information of the 3D shape of the object. For example, in a case where the 3D shape of the object is represented by a point cloud, the color information is Red, Green, and Blue values (RGB value) of each point of the point cloud. The color information is not limited to RGB values, and may be a captured image for determining the color. For example, in a case where the 3D shape of the object is represented by a mesh model, the color information may be a texture map.

The 3D shape estimation unit 3 associates the generated 3D model of the object with the captured time of the captured image, and outputs it to the association unit 4. More specifically, the 3D shape estimation unit 3 generates the 3D model of an object for each image capturing time corresponding to the image capturing performed by the plurality of image capturing units 1, and outputs the generated 3D model of the object in association with the image capturing time. At this time, the plurality of captured images corresponding to the same image capturing time may be included in the output. In the present embodiment, it is assumed that the output is directed to the association unit 4, but may alternatively be directed to a recording unit (not illustrated). In such a case, the association unit 4 acquires the 3D model organized by image capturing time from the recording unit (not illustrated). The format used for association is not limited, and, for example, the 3D model of the object and the information indicating the corresponding image capturing time may be included in a single file. Alternatively, the image capturing time may be included in a file name, and the file including the 3D model of the object may be output to the association unit 4. Here, the term “object” refers to an object for which the 3D model is to be generated, and includes a person and an item handled by the person. The image capturing time in the present embodiment is also referred to as an image capture date and time, and is the time at which each of the image capturing units 1 performs image capturing. The image capturing time may include year, month, day, hour, minute, and second.

In the present embodiment, since it is assumed that image capturing is concurrently performed for the plurality of image capturing projects, the generated 3D model includes a plurality of objects. However, there is no information indicating which component, from among the components of the generated 3D model, corresponds to which object, so that a process of separating the generated 3D model by object is performed in order to appropriately manage the 3D models of the objects for each image capturing project. In other words, the generated 3D model is divided or classified by object. In the present embodiment, the process of separating the generated 3D shape by object is performed by the object separation unit 5.

The object separation unit 5 performs the separation processing on the 3D model generated by the 3D shape estimation unit 3 so that the 3D models resulting from the separation each correspond to a corresponding object of the plurality of objects serving as image capturing targets. In the present embodiment, the 3D model generated by the 3D shape estimation unit 3 is a point cloud, and the object separation unit 5 generates a 3D model corresponding to a corresponding object by converting the point cloud into a mesh model.

A point cloud is a collection of points and does not include information indicating which 3D model each point corresponds to. In contrast, a mesh model includes information indicating the combinations of coordinates that form its constituent polygons. In a case where a group of connected polygons is regarded as a single 3D model, the coordinates contained in the polygons can be used to identify which 3D model each point corresponds to. In other words, the plurality of 3D models configuring the plurality of objects can be generated by converting the point cloud into the mesh model. Here, it is unclear which image capturing project each of the generated 3D models corresponds to, so that the project identification unit 6 performs this identification. The marching cubes method is used as the technique for converting the point cloud into a mesh model. Each of the generated 3D models is assigned a identifier and output to the project identification unit 6.

The process of separating the 3D model by object is not limited to the method described above. The object separation unit 5 may separate the point cloud into a plurality of groups without converting the point cloud into a mesh model. In this case, each of the separated plurality of groups is treated as a single 3D model. In the separation process, for each point of the point cloud, adjacent points or points located within a predetermined range from the point to be subjected to the process are treated as points configuring the point cloud for a same object. In other words, the 3D shape estimation unit 3 groups the components located near in 3D position to the 3D model generated by the 3D shape estimation unit 3, thus separating the 3D model generated by the 3D shape estimation unit 3 into the 3D models by object. The object separation unit 5 may be included in the 3D shape estimation unit 3, rather than in the association unit 4. The object separation unit 5 is not an essential component, and a configuration without the object separation unit 5 will be described in a third embodiment.

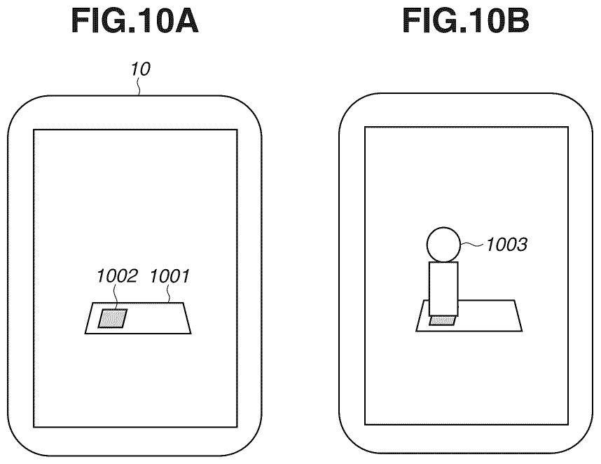

The project identification unit 6 identifies which of the plurality of 3D models of the plurality of the objects corresponds to which image capturing project, and generates information indicating the combinations thereof. The process of generating the information indicating the combinations will be specifically described below. The project identification unit 6 outputs the information indicating the combinations to the input/output unit 7, the administrator determines the combinations of the image capturing projects and the 3D models via the input/output unit 7, and generates a file for each of the image capturing projects. The file for each of the image capturing projects includes the 3D model of the object corresponding to the corresponding one of the image capturing projects. The generated file of the image capturing project is referred to as an image capturing project file, which will be specifically described with reference to FIGS. 10A and 10B. The project identification unit 6 generates the plurality of image capturing project files, and outputs the files to the recoding unit 8.

The input/output unit 7 is in charge of managing the information about the image capturing projects and generating information (hereinbelow, referred to as project identification information) used for the process of identifying which 3D model corresponds to which image capturing project. A user who requests the image capturing project inputs, via the user terminal 10, information about an image capturing time, the number of persons to be captured, and details of the props to be brought. The input/output unit 7 acquires the information, determines, based on the number of persons that can be image-captured concurrently in the image capturing area, the plurality of image capturing projects for which image-capturing can be conducted concurrently, and manages the image capturing projects. For example, if up to ten people can be image-captured concurrently in the image capturing area, the image capturing projects are managed so that no more than ten people, as objects, are image-captured at the target image-capturing time. For example, the image capturing projects are managed on a first-come, first-served basis to ensure that the number of people to be imaged does not exceed ten. After the determination of the plurality of image capturing projects for which image-capturing is to be conducted at the target image capturing time, the input/output unit 7 generates project identification information according to the number of image capturing projects. In the present embodiment, the input/output unit 7 generates the information indicating the combinations of the image capturing projects and the information about the areas as the project identification information, by dividing the image capturing area by image capturing project. This enables the project identification unit 6 to generate information indicating the association between each 3D model and its corresponding image-capturing project. For example, in a case where the number of image capturing projects to be captured concurrently is three, the project identification unit 6 divides the image capturing area into three sections and generates a table indicating the combinations of the position information for each area and its corresponding image capturing project. The information to be generated is not limited to the above; for example, the project identification unit 6 may generate information indicating combinations of an image capturing project and a position tracking device. This case will be specifically described in a second embodiment.

The input/output unit 7 outputs to the project identification unit 6 the information used for the identification process of identifying to which image capturing project the generated 3D model corresponds. An example of automatically dividing the image capturing area has been described above, but it is not restrictive. The administrator who manages the image capturing may set the image capturing area.

The input/output unit 7 performs processing of associating the generated 3D model and its corresponding image capturing project via the operation by the administrator during or after the image capturing. In this process, the input/output unit 7 acquires the information indicating the combinations of the 3D model and the image capturing project from the project identification unit 6, and displays the information in a manner recognizable by the administrator to assist the administrator to associate the 3D model and the image capturing project.

The recoding unit 8 records the image capturing project file generated by the project identification unit 6. Each image capturing project file includes the 3D model corresponding to the corresponding image capturing project. In a case where a 3D model for a specific image capturing project is requested from the management server 9, the recoding unit 8 outputs the data included in the target image capturing project file to the management server 9.

The management server 9 requests the data included in the image capturing project file of the target image capturing project from the recoding unit 8 based the information indicating the image capturing project to be acquired from the user terminal 10. Then, the management server 9 generates a virtual viewpoint image using the acquired data, and outputs it to the user terminal 10. The management server 9 acquires from the user terminal 10 the information about the position and orientation of the virtual camera used for generating the virtual viewpoint image.

The user terminal 10 is, for example, a smartphone or a tablet terminal, outputs information indicating a specific image capturing project to the management server 9, acquires a virtual viewpoint image generated by using the 3D model of the object corresponding to the specific image capturing project, and displays it on a display unit (not illustrated). For example, when the image capturing is completed, the administrator provides a card on which a quick response (QR®) code associated with the identifier of the image capturing project is described, to the user. The user reads the QR code using a camera mounted on the user terminal 10, and outputs the identifier of the image capturing project to the management server 9. The management server 9 acquires data of the target image capturing project file from the recoding unit 8 using the identifier of the image capturing project, and generates a virtual viewpoint image. The user terminal 10 acquires and displays the virtual viewpoint image. The acquired virtual viewpoint image may be displayed in a superimposed manner on another captured image. The virtual viewpoint image can be displayed as an AR image. In such a case, the captured image acquired from the camera mounted on the user terminal 10 is composited with and a virtual viewpoint image through overlaying. In overlaying, the position of the 3D model of the object included in the virtual viewpoint image may be determined based on the position of the QR code included in the captured image. Alternatively, a plane surface of a table or a chair included in the captured image is recognized to determine the position of the 3D model so that the 3D model of the object is arranged on the recognized plane surface. It is not necessary to use a card with a QR® code recorded thereon; instead, a marker associated with the identifier of the image capturing project may be printed on the card, and image recognition may be used to output the identifier of the image capturing project to the management server 9. Moreover, the medium is not limited to cards, and it may also be an acrylic stand, figure, or other similar item.

### Hardware Configuration

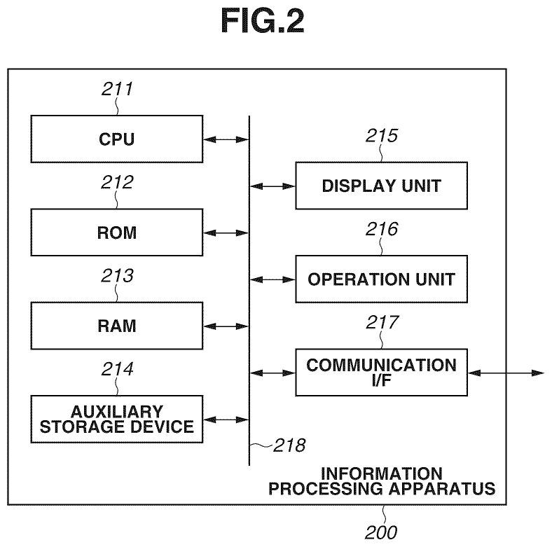

FIG. 2 is a block diagram illustrating an example of a hardware configuration of an information processing apparatus.

With reference to FIG. 2, the hardware configuration of an information processing apparatus 200 will be described. The information processing apparatus 200 includes a central processing unit (CPU) 211, a read only memory (ROM) 212, a random access memory (RAM) 213, an auxiliary storage device 214, a display unit 215, an operation unit 216, a communication interface (I/F) 217, and a bus 218.

The CPU 211 controls the entire information processing apparatus 200 using computer programs and data stored in the ROM 212 or the RAM 213 to implement various functions of the information processing apparatus 200 illustrated in FIG. 1. The information processing apparatus 200 may include one or a plurality of dedicated hardware configurations different from the CPU 211 to execute at least a part of the process performed by the CPU 211. Examples of the dedicated hardware configurations include an application specific integrated circuit (ASIC), field programmable gate array (FPGA), and a digital signal processor (DSP). The ROM 212 stores programs or the like that do not need to be changed. The RAM 213 temporarily stores programs and data supplied from the auxiliary storage device 214, and data or the like externally supplied via the communication I/F 217.

The auxiliary storage device 214 includes, for example, a hard disk drive, and stores various types of data, such as image data and audio data.

The display unit 215 includes, for example, a liquid crystal display or light-emitting diodes (LEDs), and displays a graphical user interface (GUI) or the like used by a user for operating the information processing apparatus 200. The operation unit 216 includes, for example, a keyboard, a mouse, a joy stick, and a touch panel to input various instructions to the CPU 211 in response to user's operations. The CPU 211 operates as a display control unit for controlling the display unit 215, and an operation unit control unit for controlling the operation unit 216. The communication I/F 217 is used for communicating with an external apparatus of the information processing apparatus 200. For example, in a case where the information processing apparatus 200 is connected to the external apparatus via a cable, the cable for communication is connected to the communication I/F 217. In a case where the information processing apparatus 200 has a function of wirelessly communicating with the external apparatus, the communication I/F 217 includes an antenna. The bus 218 connects the components in the information processing apparatus 200 to transmit and receive information.

In the present embodiment, the display unit 215 and the operation unit 216 are included in the information processing apparatus 200, but at least one of the display unit 215 and the operation unit 216 may be disposed as an independent apparatus outside the information processing apparatus 200.

### Generation Processing of Project identification Information

The project identification information is generated by the input/output unit 7. After the plurality of image capturing projects to be captured at the target image capturing time is determined, information indicating combinations of the image capturing project and the area information is generated by dividing the image capturing area by image capturing project.

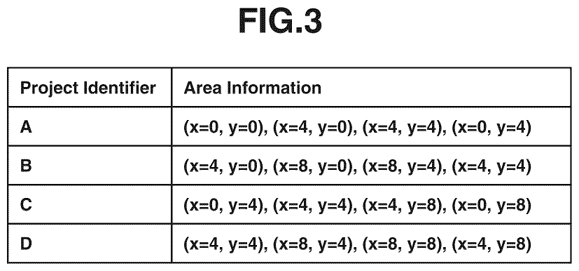

FIG. 3 is a table illustrating an example of the project identification information according to the first embodiment. The project identification information includes a project identifier serving as an identifier of an image capturing project, and area information indicating coordinates of four corners configuring a partial area generated by dividing the image capturing area. No restrictions are considered in the vertical direction of the image capturing area, so that the coordinates of the partial area are represented using X axis coordinates and Y axis coordinates in a virtual space defined by three axes: X, Y, and Z. The project identification information may include a name of the image capturing project instead of the project identifier. Assume that the project identification information is generated in advance before the image capturing. The use of the project identification information enables identification of the image capturing project to which the generated 3D model corresponds. In FIG. 3, the project identification information in a case where the image capturing area is equally divided into four areas for four image capturing projects, but this is not limited to such a configuration.

For example, if the number of people to be image captured in the image capturing projects with a project identifier A is four, and the image capturing projects with project identifiers B to D each involve only one person, then it is acceptable to set half of the image capturing area to the area information for the image capturing projects with the project identifier A. In this case, the remaining half of the partial area is divided into three, and the three areas are set as pieces of area information corresponding to the image capturing projects with the project identifiers B to D. In a case where there are many objects desired to be captured in one image capturing project, a plurality of partial areas may be set so as to correspond to one image capturing project. Any configuration that enables identification of the image capturing project to which the partial area corresponds to, is applicable. The image capturing area is not limited to the area automatically set by the input/output unit 7, and the administrator who manages the image capturing may freely set the image capturing area.

### Identification Processing of Image Capturing Project Corresponding to 3D Model

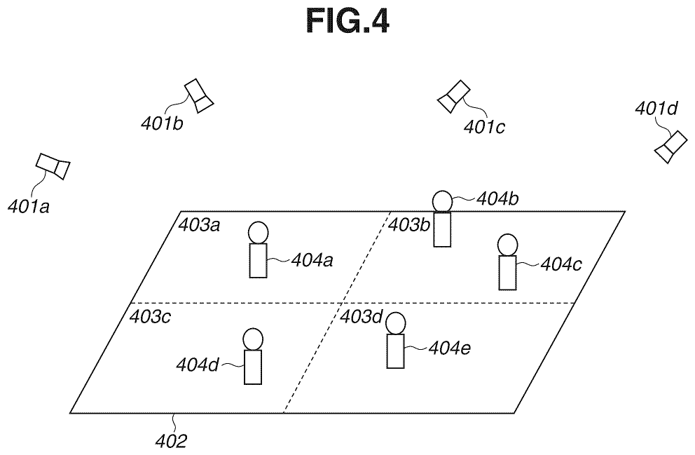

FIG. 4 is a diagram illustrating a process of identifying an image capturing project corresponding to a 3D model of an object according to the first embodiment. Image capturing apparatuses 401a, 401b, 401c, and 401d are arranged so as to surround an image capturing area 402. In the present embodiment, image capturing is performed concurrently for four image capturing projects in the image capturing area 402, and 3D models each corresponding to the corresponding one of the four image capturing projects are generated concurrently. At this time, it is assumed that the image capturing projects to which the 3D models correspond are identified using position information for the 3D models corresponding to the objects, and the image capturing area 402 is divided into four partial areas by image capturing project. In other words, one image capturing project corresponds to one partial area, and an object performs in a designated partial area. A partial area 403a includes an object 404a. A partial area 403b includes objects 404b and 404c. A partial area 403c includes an object 404d. A partial area 403d includes an object 404e.

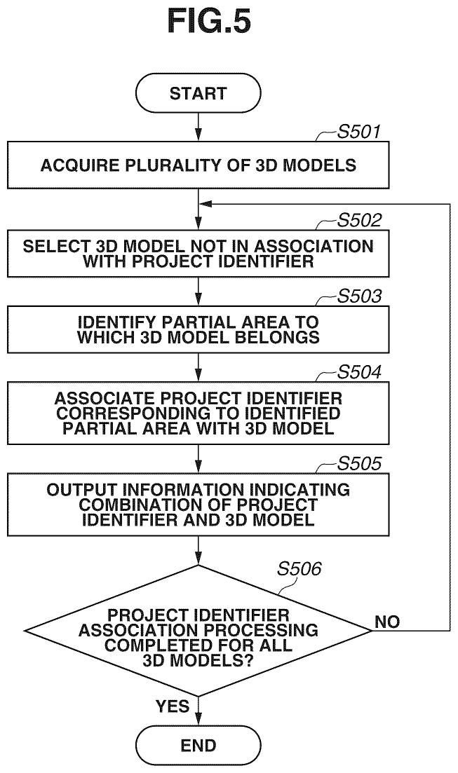

FIG. 5 is a flowchart illustrating a process which is performed by the project identification unit 6 according to the first embodiment. This process is assumed to be performed for each frame.

In step S501, the project identification unit 6 acquires a plurality of 3D models corresponding to a plurality of objects from the object separation unit 5. In this operation, the project identification unit 6 acquires position information for the plurality of 3D models. For example, the position information about the 3D model is a centroid position of each 3D model. In the present embodiment, the project identification unit 6 is assumed to acquire the project identification information in advance from the input/output unit 7, but if not acquired, the project identification unit 6 acquires the project identification information in this step.

In step S502, the project identification unit 6 selects a 3D model that is not associated with the project identifier of any of the image capturing projects. Alternatively, the project identification unit 6 may select the 3D model that is not associated with any project identifier, by performing process in the order of the identifiers assigned to the 3D models by the object separation unit 5.

In step S503, the project identification unit 6 identifies a partial area to which the selected 3D model belongs from among the plurality of partial areas. More specifically, the project identification unit 6 identifies the partial area including the centroid position of the selected 3D model. In other words, the project identification unit 6 identifies the corresponding partial area using the position information about the 3D model.

In step S504, the project identification unit 6 associates the project identifier corresponding to the identified partial area with the 3D model. The project identification unit 6 performs this process based on the project identification information because the project identification information includes the project identifier corresponding to the partial area. This enables clear identification of which image capturing project the respective 3D models correspond to.

In step S505, the project identification unit 6 outputs to the recoding unit 8 information indicating the combination of the 3D model and the project identifier of the corresponding image capturing project based on the information associated in step S504.

In step S506, the project identification unit 6 determines whether the process of associating the identifier of the image capturing project with the corresponding 3D model has been executed for all the 3D models. If all 3D models have been subjected to the process of associating the identifier of the corresponding image capturing project (YES in step S506), the processing is ended. If there is any 3D model on which the process of associating the identifier of the corresponding image capturing project has not been executed (NO in step S506), the processing returns to S502.

Through the processes described above, the image capturing project corresponding to the corresponding 3D model of the generated 3D models can be identified.

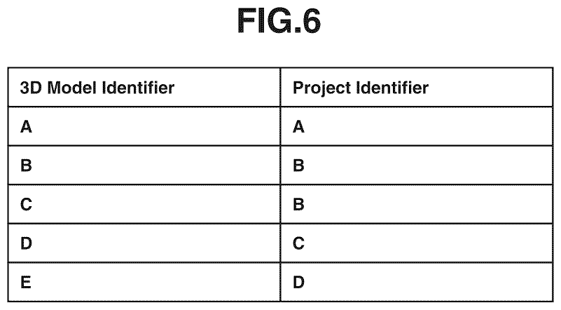

FIG. 6 is a table illustrating information indicating combinations of a 3D model or models and its corresponding image capturing project, generated by the project identification unit 6 according to the first embodiment. Based on the information, the project identification unit 6 can manage the appropriate 3D model for each image capturing project. The table of the 3D model identifiers and the project identifiers illustrated in FIG. 6 is an example, and it is not necessarily a tabular format. It is sufficient if the correspondence relationship between the 3D model and the image capturing project is recognizable, and, for example, in a case where the 3D model is managed by the recoding unit 8 for each object, metadata of each 3D model may include the project identifier of the corresponding image capturing project or the name of the image capturing project. The metadata of the 3D model may include both the project identifier and the name of the image capturing project. The information indicating the correspondence relationship enables generation of an image capturing project file including the appropriate 3D model for each image capturing project.

In a case where an object performs near the boundary of the partial areas, the 3D model of this object may be erroneously associated with a different image capturing project. Thus, the administrator may check whether the information indicating the combination of a 3D model and the image capturing project generated by the project identification unit 6 is correct. The administrator can check whether the information indicating the combination of a 3D model and the image capturing project via the input/output unit 7. It is conceivable that, in performing image capturing for a single image capturing project, the same performance may be image-captured for a plurality of times, and a 3D model and/or a moving image corresponding to the image capturing in which the desired performance is achieved may be adopted as the deliverable. During such a plurality of times of image capturing, the object may adjust their performance position and act away from the boundaries of the partial area. Therefore, the process in which the administrator confirms and modifies the information indicating the association between the 3D model and the image capturing project is not an essential configuration.

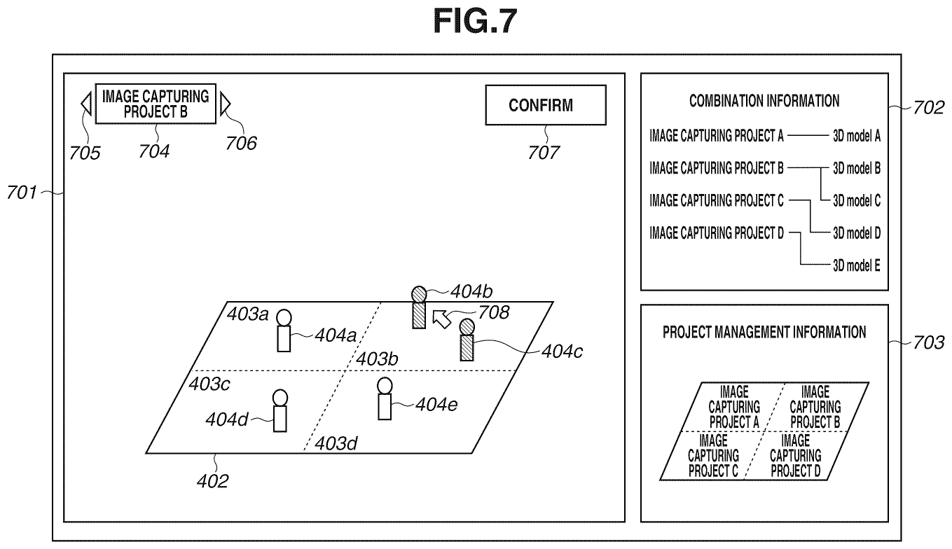

FIG. 7 is a diagram illustrating a confirmation screen for the information indicating the combinations of a 3D model or models and an image capturing project displayed on the input/output unit 7 according to the first embodiment. The administrator checks whether the combinations of the 3D models and the image capturing projects are correct using the confirmation screen, and if there is an error, the administrator corrects the error. In a screen area 701, the image capturing area 402, the partial area 403a to 403d, and images indicating the 3D models of the objects 404a to 404e are displayed. The screen area 701 further includes an area 704 indicating a currently selected image capturing project, buttons 705 and 706 for selecting an image capturing project, and a button 707 for confirming the combination when the check and the correction are completed. The 3D model associated with the currently selected image capturing project is displayed in a recognizable manner. For example, in a case where an image capturing project B is selected, information indicating that the image capturing project B is selected is displayed in the area 704, and the 3D models of the objects 404b and 404c associated with the image capturing project B are displayed in a highlighted manner. In contrast, the 3D models not associated with the image capturing project B are not displayed in a highlighted manner. The highlighted display is not limited to shading processing, and color information may be changed, or the size of the 3D model may be made larger. In a case where the combination information is incorrect, the administrator corrects the combination information by moving a cursor 708 and clicking the 3D model. In a case where the 3D model not displayed in a highlighted manner is clicked, the 3D model changes to be displayed in a highlighted manner. On the other hand, in a case where the 3D model displayed in a highlighted manner is clicked, the 3D model changes not to be displayed in a highlighted manner. The administrator can correct the combination information by performing the operation on the currently selected image capturing project so that the appropriate 3D model is displayed in a highlighted manner. In a case where the input/output unit 7 is an apparatus provided with a touch panel, the administrator may use a touch operation instead of the click operation. When the check and the correction of the information of the combination of the 3D model(s) and the image capturing project are completed, the administrator ends the processing of the check and correction by clicking the button 707. In a screen area 702, the information indicating the combinations of each of the image capturing projects and the 3D model or models is displayed. The information displayed in the screen area 702 is assumed to be sequentially updated based on the adjustment by the administrator. At the check time and the adjustment start time, the information indicating the combinations of the 3D model or models generated by the project identification unit 6 and each of the image capturing projects is used as initial information. In a screen area 703, the project management information generated by the input/output unit 7 is displayed. The information displayed in the screen areas 702 and 703 may be displayed in a tabular format. The confirmation screen may be generated by the input/output unit 7 or the project identification unit 6.

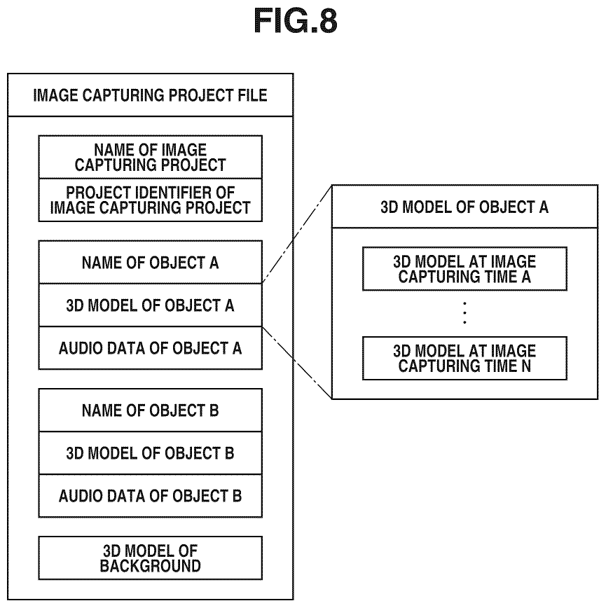

FIG. 8 is a diagram illustrating an image capturing project file including data for each image capturing project generated by the project identification unit 6 according to the first embodiment. Since this file is output to the recoding unit 8, the file can be paraphrased as the file to be recorded in the recoding unit 8. The image capturing project file is generated for each image capturing project, and includes data associated with the image capturing project. More specifically, the image capturing project file includes the name of the image capturing project, the project identifier of the image capturing project, the names of the object of the 3D models associated with the image capturing project, the 3D models of the objects, and audio data of the objects. It is sufficient for the image capturing project file to include the project identifier of the image capturing project and the 3D model(s) of the object(s), and other types of information may be omitted. In a case where a plurality of objects corresponds to one image capturing project, data for each object is recorded in a distinguished manner. In the example illustrated in FIG. 8, the data for each of objects A and B is recorded separately. More specifically, the name of the object A, the 3D model of the object A, the audio data of the object A, the name of the object B, the 3D model of the object B, and the audio data of the object B are recorded in the image capturing project file. In a case where the 3D model of the background used for the image capturing project is determined in advance, the image capturing project file may include the 3D model of the background. The name of the object may be included in the metadata of the 3D model of the object and/or the metadata of the audio data of the object. In the present embodiment, a 3D model is generated for a predetermined duration, so that the 3D models for that duration are collectively included in a file. A 3D model is generated for each image capturing time, so that the plurality of 3D models may be managed by arranging the 3D models in order of the image capturing time. FIG. 8 illustrates, as an example, a file storing the 3D models of the object A arranged in order from an image capturing time A to an image capturing time N. Alternatively, instead of using the image capturing time, the 3D models may be recorded in association with a timecode that represents the start time of image capturing by the imaging device, expressed as “00 (hour): 00 (minute): 00 (second): 000 (frame).

Generating and recording the image capturing project file including appropriate data for each image capturing project as described above enables the management server 9 to acquire required data for each image capturing project to generate the virtual viewpoint image.

The above-described embodiment facilitates appropriate management of a 3D model(s) for each image capturing project, while allowing image capturing to be performed concurrently for a plurality of image capturing projects. In typical techniques, an administrator has to manually check and associate each 3D model with its corresponding image capturing project. With the above embodiment, such associations can be made more efficiently.

If specific data to be used in combination with the 3D model of the object is predetermined for each image capturing project, such data or information indicating the data may be stored as metadata of the 3D model of the object, or the 3D model of the object and the data may be managed in association with each other. Examples of data to be used in combination with the 3D model of the object include a background 3D model, background texture images, and 3D models of props. Through the above, deliverables can be collectively managed for each image capturing project.

### Utilization Method for Image Capturing Project File

For example, the generated image capturing project file is utilized for generating an AR image. The identifier of the image capturing project included in the image capturing project file is converted into a QR® code, and recorded in a medium, such as a card and an acrylic display stand. A user can display an AR image generated using the 3D model of the object corresponding to the image capturing project by reading the card with the QR® code recorded thereon using the user terminal 10.

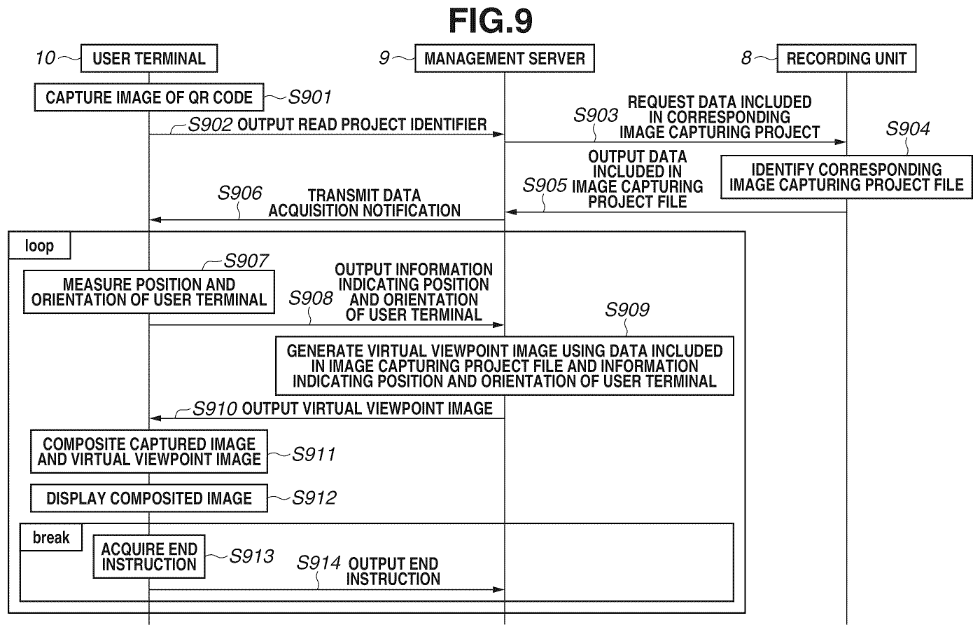

FIG. 9 is a sequence diagram illustrating process of displaying an AR image of a 3D model of an object corresponding to an image capturing project according to the first embodiment.

In step S901, the user terminal 10 captures an image of a QR® code. It is not limited to the QR code, and, for example, the user terminal 10 may capture an image of a specific marker or a bar code. The QR® code indicates the project identifier of an image capturing project, and the user terminal 10 acquires the project identifier of the image capturing project through image capturing.

In step S902, the user terminal 10 transmits the read project identifier of the image capturing project to the management server 9. The information read by capturing the image of the QR® code is not limited to the project identifier of the image capturing project, and, for example, may be the address indicating the location at which the image capturing project file corresponding to the image capturing project is stored in the recoding unit 8, or may be the name of the image capturing project.

In step S903, the management server 9 requests data included in the image capturing project file corresponding to the acquired project identifier of the image capturing project from the recoding unit 8.

In step S904, the recoding unit 8 identifies the image capturing project file corresponding to the request.

In step S905, the recoding unit 8 outputs data included in the identified image capturing project file to the management server 9.

In step S906, the management server 9 notifies the user terminal 10 of the data acquisition when the management server 9 has completed the acquisition of the data included in the image capturing project file.

In step S907, the user terminal 10 measures the position and orientation of the user terminal 10. These are measured using a gyroscope sensor, a magnetic sensor, or a light detection and ranging (LiDAR) device mounted on the user terminal 10, and/or image recognition using the QR® code included in the captured image. The operations in steps S907 to S912 are looped until the user inputs an end instruction. When the user inputs an end instruction, the processing proceeds to step S913 to end the loop processing.

In step S908, the user terminal 10 outputs information indicating the measured position and orientation to the management server 9.

In step S909, the management server 9 generates a virtual viewpoint image using the data included in the image capturing project file acquired from the recoding unit 8, and the information acquired from the user terminal 10 and indicating the position and orientation of the user terminal 10. The management server 9 determines the position and orientation of the virtual camera in a virtual space using the information indicating the position and orientation of the user terminal 10, and generates the virtual viewpoint image using the position and orientation of the virtual camera and the 3D model of the object included in the image capturing project file. The virtual viewpoint image may be generated using only the data included in the image capturing project file, or may be generated by the combination of the data recorded in the management server 9 and the data included in the image capturing project file. In a case where the data included in the image capturing project file is only the 3D model of the object, the management server 9 generates the virtual viewpoint image including only the 3D model of the object.

In step S910, the management server 9 outputs the generated virtual viewpoint image to the user terminal 10.

In step S911, the user terminal 10 combines the captured image acquired from the camera mounted on the user terminal 10, and the virtual viewpoint image acquired from the management server 9 to generate a composited image.

More specifically, the user terminal 10 generates the composited image by compositing the captured image with the virtual viewpoint image through overlaying. In overlaying the virtual viewpoint image, the user terminal 10 may perform the overlaying so that the 3D model of the object is displayed on the QR code with the position of the QR® code included in the captured image as a reference.

In step S912, the user terminal 10 displays the generated composited image.

In step S913, the user terminal 10 acquires an instruction to end the AR display by a user operation.

In step S914, the user terminal 10 outputs the end instruction to the management server 9. This processing ends the loop processing.

Through the processing described above, the user can view the AR image generated using the 3D model corresponding to the specific image capturing project. The user is not limited to the client who requests the image capturing project, and may be a person who captures the image of the card with the QR® code, different from the client.

FIGS. 10A and 10B are diagrams each illustrating an example of an AR image displayed on the user terminal 10 according to the first embodiment.

FIG. 10A is a diagram illustrating a scene in which a card with a QR® code is being captured by the camera installed in the user terminal 10. The captured image includes a card 1001 and the QR® code 1002.

FIG. 10B is a diagram illustrating an AR image displayed by scanning a QR® code. In this embodiment, an AR image refers to a composited image generated by overlaying a captured image and a virtual viewpoint image.

An AR image is generated by overlaying a captured image and a virtual viewpoint image so that a 3D model 1003 of an object is displayed on the QR® code included in the captured image. The user can change the position and orientation of the virtual camera by adjusting the position and orientation of the user terminal 10.

If the object performs for 30 seconds during the image capturing, a 3D model representing the entire 30-second performance is generated.

Thus, in the AR image, a 3D model that moves for 30 seconds can be displayed. The 3D model that restarts its performance from the beginning when the 30-second motion is completed is displayed, so that the model continues to be displayed in a loop until the user issues an end instruction. The user can pause the motion of the 3D model by performing a tap operation on the screen. Additionally, by swiping to the left side of the screen, the 3D model corresponding to five seconds before the image capturing time associated with the 3D model that is displayed at the time of operation may be displayed. By swiping to the right side of the screen, the 3D model corresponding to five seconds after the image capturing time associated with the 3D model that is displayed at the time of operation may be displayed.

In the embodiment described above, an example where the image capturing project file is utilized for an AR image is described. However, it is not limited thereto, and a 3D model may be delivered to the user terminal 10.

### Second Embodiment

In the first embodiment, the corresponding image capturing project is identified based on which partial area each of a plurality of 3D models, corresponding to a plurality of objects, belongs to. However, since the objects are required to perform within the corresponding partial region, it may be difficult to perform within the partial area in cases where the object moves significantly during image capturing, such as with a skateboard. Therefore, in a second embodiment, trackers for acquiring positional information are distributed for the respective objects, and image-capturing is performed with subject wearing a tracker.

The image processing system identifies to which image capturing project a generated 3D model corresponds by associating the tracker identifier and the image capturing project in advance.

In the present embodiment, a device capable of acquiring position information and tracking an object is referred to as a tracker. More specifically, a global positioning system (GPS) tracker is used. However, it is not limited thereto, and the acquisition of the position information and the tracking may be performed by using a radio-frequency identification (RFID), or capturing an image of a barcode by a plurality of cameras and using an image recognition. An ultrawideband (UWB) sensor may also be used.

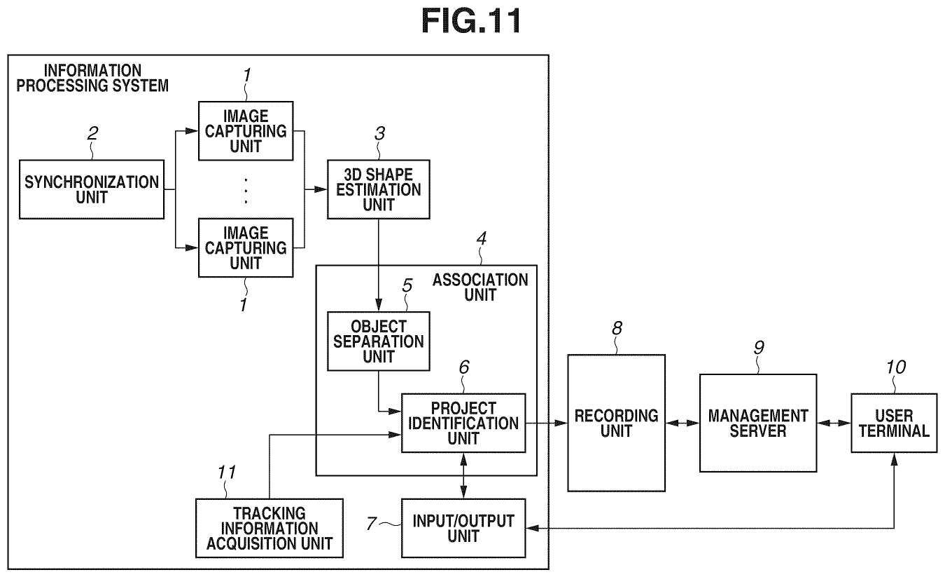

FIG. 11 is a block diagram illustrating an example of an entire system according to the second embodiment. In addition to the entire system in FIG. 1, the image processing system in FIG. 11 includes a tracking information acquisition unit 11.

The tracking information acquisition unit 11 acquires position information for a tracker to be distributed to each object. In a case where a GPS tracker is used as the tracker, the tracking information acquisition unit 11 acquires the position information for each tracker from an external server (not illustrated). The tracking information acquisition unit 11 is not an essential component, and the input/output unit 7 may acquire the position information for each tracker. For example, the plurality of image capturing units 1 may include infrared sensors or the like to acquire the position information of each tracker.

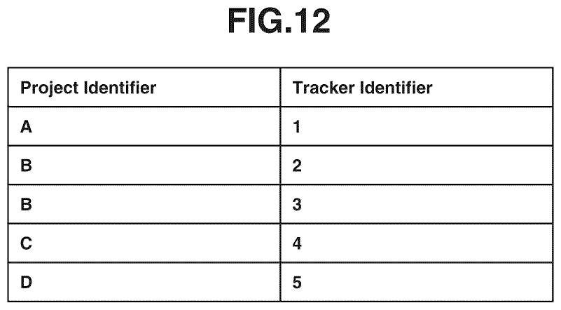

FIG. 12 is a table illustrating an example of project identification information according to the second embodiment. The project identification information according to the second embodiment includes a table including project identifiers serving as the identifiers of the corresponding image capturing projects, and tracker identifiers serving as the corresponding tracker identifiers. In other words, the project identification information indicates to which image capturing project each tracker corresponds. The project identification information is generated by the input/output unit 7 before the image capturing. In the example illustrated in FIG. 12, a tracker identifier 1 is associated with a project identifier A of an image capturing project. A tracker identifier 2 and a tracker identifier 3 are associated with a project identifier B. A tracker identifier 4 is associated with a project identifier C. A tracker identifier 5 is associated with a project identifier D.

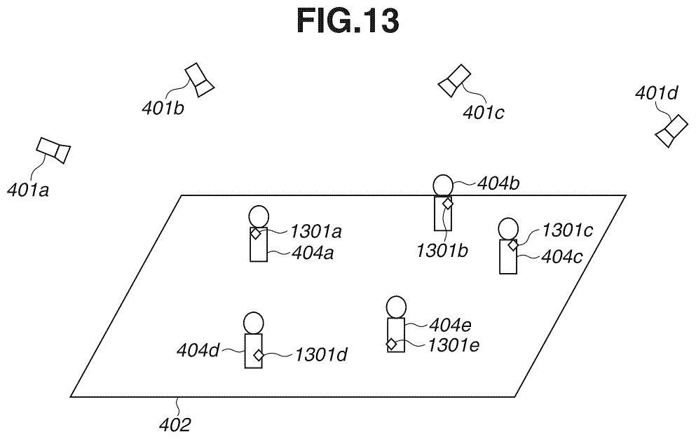

FIG. 13 is a diagram illustrating an image capturing system according to the second embodiment. In the present embodiment, a tracker is distributed to objects, and the objects perform action while wearing trackers. In the example illustrated in FIG. 13, an object 404a performs while wearing a tracker 1301a. An object 404b performs while wearing a tracker 1301b. An object 404c performs while wearing a tracker 1301c. An object 404d performs while wearing a tracker 1301d. An object 404e performs while wearing a tracker 1301e.

In skateboarding, a skateboarder and a board may become physically separated.

As described above, depending on the object of the image capturing, there may be cases where the person and their tool become physically separated. To address this, a tracker is attached also to the tool in a case where such a tool is used in the performance. In this way, even in a case where the 3D model generated when the person and the tool are physically separated, it is possible to identify to which of the person or the tool each of the 3D models corresponds, and appropriately associate them with the corresponding image capturing project.

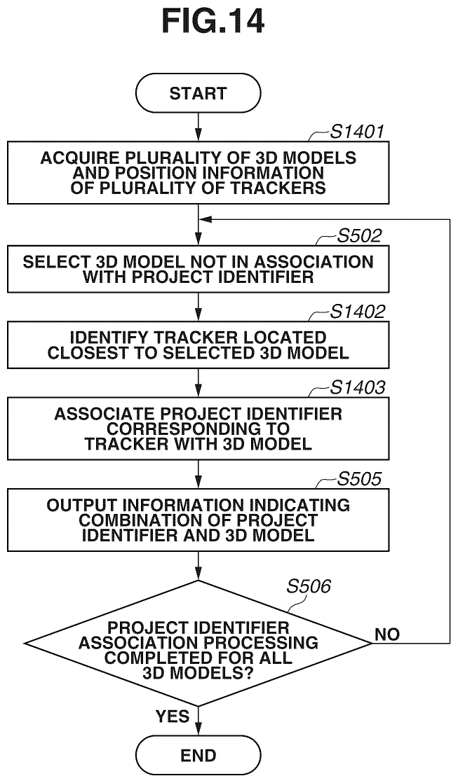

FIG. 14 is a flowchart illustrating processing performed by the project identification unit 6 according to the second embodiment. Descriptions of the processes that are similar to those in FIG. 5 are omitted.

In step S1401, the project identification unit 6 acquires a plurality of 3D models corresponding to a plurality of objects from the object separation unit 5, and position information for each tracker from the tracking information acquisition unit 11. In a case where the project identification unit 6 has not acquired the project identification information, the project identification unit 6 acquires the project identification information from the input/output unit 7 in this step.

In step S1402, the project identification unit 6 identifies a tracker located closest to the selected 3D model from among the plurality of trackers. In this operation, the project identification unit 6 identifies the tracker using the position information about the 3D model and the position information about each tracker, both of which are acquired in step S1401. More specifically, the project identification unit 6 identifies the tracker located closest to the centroid position of the 3D model.

In step S1403, the project identification unit 6 associates the project identifier of the image capturing project corresponding to the identified tracker with the corresponding 3D model.

In image capturing with a tracker attached to a tool, the 3D model of a person and the 3D model of the tool are individually generated when the person and the tool are physically separated, different trackers are identified for the respective 3D models. In contrast, in a case where the person and the tool are physically in contact with each other and one 3D model including the person and the tool is generated, two trackers are identified for the one 3D model. In an image capturing project of capturing a plurality of objects, there may be a demand to generate virtual viewpoint images that include only the 3D model of a specific object. Thus, in the case where two trackers are identified for one 3D model, it is necessary to determine which object associated with the corresponding tracker the specific 3D model corresponds to. Thus, in a case where a tracker is attached to a tool in the image capturing, the input/output unit 7 adds information indicating a type of the object corresponding to the corresponding tracker identifier to the image capturing project information illustrated in FIG. 12. Examples of the information indicating a type of an object include a person and a tool. In a case where a plurality of trackers is associated with one 3D model, a tracker to which the type of the object corresponding to the tracker identifier is set to a person is prioritized for association with the 3D model. In this way, in a case where a virtual viewpoint image including only the 3D model of the specific object performing with a tool from among the plurality of objects is intended to be generated, it is possible to generate the virtual viewpoint image, which is generated using the 3D model including the person, regardless of whether the person and the tool are in contact with each other.

The processing described above allows the object to perform without being restricted to a specific area, so that a wider variety of image capturing projects can be accommodated.

### Embodiment 3

In the first embodiment, the object separation unit 5 performs the process of separating the 3D model generated by the 3D shape estimation unit 3 into the plurality of 3D models corresponding to the plurality of objects. In a case where the data provided to the user terminal 10 is a virtual viewpoint image generated by the management server 9, the processes described above is not essential. In a third embodiment, an example of a case where the object separation unit 5 is not included in the information processing system will be described.

In the present embodiment, an example of a case where the 3D model generated by the 3D shape estimation unit 3 is a point cloud will be described. In the case where the 3D model is a point cloud, the 3D model cannot be separated into the point cloud corresponding to the object if the object separation unit 5 does not exist, so that the project identifier of the 3D model cannot be identified. Thus, the project identification unit 6 cannot generate the information indicating the combinations of the 3D models and the image capturing projects. Accordingly, unlike the first embodiment, the project identification unit 6 in the present embodiment does not generate the image capturing project file, but instead generates a file including the plurality of 3D models and the project identification information and outputs the file to the recoding unit 8. This file is generated for each image capturing time, so that this file will hereafter be referred to as an image capturing time file.

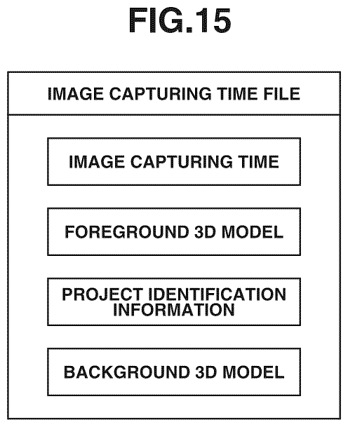

FIG. 15 is a diagram illustrating an image capturing time file including data for each image capturing time according to the third embodiment. This file is generated by the project identification unit 6. The image capturing time file includes an image capturing time, a 3D model of a foreground including a plurality of objects, project identification information, and a 3D model of a background. The 3D model of the background is not essential. The image capturing time file may include audio data.

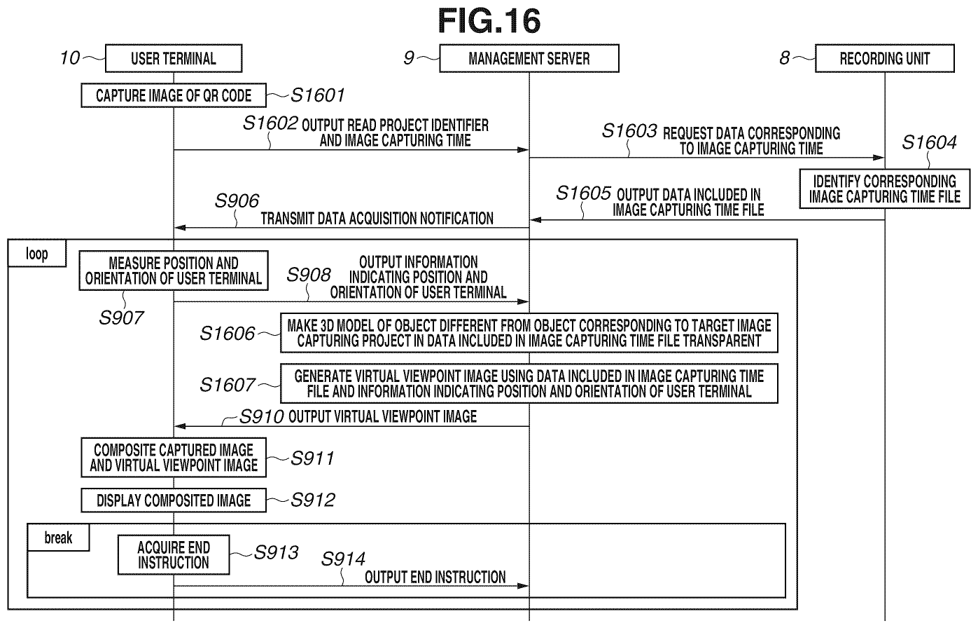

FIG. 16 is a sequence diagram illustrating process of displaying an AR image of a 3D model of an object corresponding to an image capturing project according to the third embodiment. Descriptions of the operations similar to those in FIG. 9 are omitted.

In step S1601, the user terminal 10 captures an image of a QR® code. The QR® code indicates the project identifier of the image capturing project and the image capturing time at which the image capturing project is captured, and the user terminal 10 acquires them by the image capturing. In a case where the image capturing is performed for 30 seconds in the image capturing project, the QR® code indicates the image capturing time for 30 seconds.

In step S1602, the user terminal 10 outputs the read project identifier and the image capturing time to the management server 9.

In step S1603, the management server 9 requests data corresponding to the acquired image capturing time from the recoding unit 8.

In step S1604, the recoding unit 8 identifies the corresponding image capturing time file based on the acquired request.

In step S1605, the recoding unit 8 outputs the data of the identified image capturing time file.

In step S1606, the management server 9 uses the project identifier and the project identification information included in the image capturing time file, both obtained in step S1602, to perform a process that makes the 3D models that do not correspond to the target image capturing project transparent, from the data included in the image capturing time file at the processing target image capturing time. More specifically, the management server 9 identifies the 3D models not included in the partial area corresponding to the project identifier of the image capturing project acquired in step S1602, from among the 3D models (3D models each including a plurality of objects) of the foregrounds included in the image capturing time file. Then, the management server 9 sets the color of the identified 3D models to be colorless and transparent. Through this process, it becomes possible to generate the virtual viewpoint image including only the 3D model corresponding to the project identifier of the image capturing project read by the user capturing the image of the QR® code.

In step S1607, the management server 9 generates a virtual viewpoint image using the data of the image capturing time file at the image capturing time of the processing target, and the information indicating the position and orientation of the user terminal 10. Since the 3D models corresponding to the non-target image capturing projects have become transparent in step S1606, the generated virtual viewpoint image does not include the 3D models corresponding to the non-target image capturing projects.

Through the processing described above, the virtual viewpoint image including only the 3D model of the object corresponding to the specific image capturing project is generated, even in the case where the 3D model including the plurality of objects is generated by capturing the plurality of image capturing projects. In a case where the image capturing time file includes a background model, the virtual viewpoint image includes also a background model.

The case where the 3D model is a point cloud is described above, but it is not limited thereto. In a case where the 3D model generated by the 3D shape estimation unit 3 is a mesh model, a plurality of mesh models corresponding to a plurality of objects can be separated based on whether polygons are connected. Thus, the 3D shape estimation unit 3 may assign the project identifier of a 3D model to each mesh model, enabling project identification unit 6 to generate the information indicating the combination of the 3D model and the image capturing project. In such cases, the management server 9 may generate the image capturing project file or the image capturing time file.

An example in which the image capturing time file includes the project identification information has been described above, but it is not limited thereto. For example, the project identification unit 6 may identify to which partial area each component of the 3D model corresponds in advance, and may assign to the metadata of the 3D model the information indicating the combination of each component and the image capturing project corresponding to the identified partial area identified as each component.

### Other Embodiments

In the embodiments described above, since image capturing is performed concurrently for the plurality of image capturing projects, when sounds of a plurality of objects are recorded concurrently, there is a possibility that appropriate sounds cannot be recorded because voices of other objects are mixed. For this reason, it is assumed to collect the sounds for each image capturing project after completing the image capturing for generating the 3D model of the object. In this case, the sound collection is performed while watching the virtual viewpoint image generated using the 3D model associated for each image capturing project. The audio data acquired by the sound collection is managed in association with the 3D model associated with the corresponding image capturing project. For example, a folder is generated for each image capturing project, and the 3D model and the audio data corresponding to the corresponding image capturing project may be stored and managed.

An example in which the image capturing of the object and the collection of the sounds are separately performed is described above, but it is not limited thereto. For example, the image capturing and the sound collection may be performed concurrently by proving earphones and a directional microphone to each object.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, the generated 3D model can be easily managed for each image capturing project.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-137658, filed Aug. 19, 2024, which is hereby incorporated by reference herein in its entirety.

What is claimed is:

1. An information processing system comprising:
one or more memories storing instructions; and
one or more processors executing the instructions to
acquire a plurality of three-dimensional models generated based on a plurality of captured images obtained by concurrently capturing objects each corresponding to a respective image capturing project of a plurality of image capturing projects, and acquire position information of a capture area corresponding to each of the plurality of image capturing projects,
associate, based on the plurality of three-dimensional models and the position information, each of the plurality of image capturing projects with a three-dimensional model existing within the capture area corresponding to the image capturing project, and
output information indicating a combination of the associated image capturing project and the three-dimensional model.

2. The information processing system according to claim 1, wherein the one or more processors further execute the instructions to generate, based on the information, a plurality of files including the three-dimensional models of the objects corresponding to the image capturing projects.

3. The information processing system according to claim 2, wherein the one or more processors further execute the instructions to:
identify, from among the plurality of files, a file corresponding to an image capturing project specified by a first user operation; and
generate a virtual viewpoint image using the three-dimensional model included in the identified file.

4. The information processing system according to claim 3, wherein the one or more processors further execute the instructions to perform control to display a composited image generated using a captured image acquired based on a second user operation, and the virtual viewpoint image.

5. The information processing system according to claim 4, wherein the one or more processors further execute the instructions to correct, based on a third user operation, the information indicating the combination of the image capturing project and the three-dimensional model.

6. The information processing system according to claim 5,
wherein the first user operation and the second user operation are performed by a first user, and
wherein the third user operation is performed by a second user.

7. An information processing system comprising:
one or more non-transitory memories storing instructions; and
one or more processors configured to execute the instructions to:
acquire a plurality of three-dimensional models generated based on a plurality of captured images obtained by concurrently capturing objects, each object corresponding to a respective image capturing project of a plurality of image capturing projects, and acquire position information of a tracking device corresponding to each of the plurality of image capturing projects;
associate, based on the plurality of three-dimensional models and the position information of the tracking devices, each of the plurality of image capturing projects with a three-dimensional model located closest to the position of the tracking device corresponding to the image capturing project; and
output information indicating a combination of the associated image capturing project and the three-dimensional model.

8. An information processing method comprising:
acquiring a plurality of three-dimensional models generated based on a plurality of captured images obtained by concurrently capturing objects each corresponding to a respective image capturing project of a plurality of image capturing projects, and acquiring position information of a capture area corresponding to each of the plurality of image capturing projects,
associating, based on the plurality of three-dimensional models and the position information, each of the plurality of image capturing projects with a three-dimensional model existing within the capture area corresponding to the image capturing project, and
outputting information indicating a combination of the associated image capturing project and the three-dimensional model.

9. A non-transitory computer readable storage medium storing a program for causing a computer to perform an information processing method comprising:
acquiring a plurality of three-dimensional models generated based on a plurality of captured images obtained by concurrently capturing objects each corresponding to a respective image capturing project of a plurality of image capturing projects, and acquiring position information of a capture area corresponding to each of the plurality of image capturing projects,
associating, based on the plurality of three-dimensional models and the position information, each of the plurality of image capturing projects with a three-dimensional model existing within the capture area corresponding to the image capturing project, and
outputting information indicating a combination of the associated image capturing project and the three-dimensional model.

10. An information processing method comprising:
acquiring a plurality of three-dimensional models generated based on a plurality of captured images obtained by concurrently capturing objects, each object corresponding to a respective image capturing project of a plurality of image capturing projects, and acquiring position information of a tracking device corresponding to each of the plurality of image capturing projects;
associating, based on the plurality of three-dimensional models and the position information of the tracking devices, each of the plurality of image capturing projects with a three-dimensional model located closest to the position of the tracking device corresponding to the image capturing project; and
outputting information indicating a combination of the associated image capturing project and the three-dimensional model.

11. A non-transitory computer readable storage medium storing a program for causing a computer to perform an information processing method comprising:
acquiring a plurality of three-dimensional models generated based on a plurality of captured images obtained by concurrently capturing objects, each object corresponding to a respective image capturing project of a plurality of image capturing projects, and acquiring position information of a tracking device corresponding to each of the plurality of image capturing projects;
associating, based on the plurality of three-dimensional models and the position information of the tracking devices, each of the plurality of image capturing projects with a three-dimensional model located closest to the position of the tracking device corresponding to the image capturing project; and
outputting information indicating a combination of the associated image capturing project and the three-dimensional model.
